(19) United States
(12) Patent Application Publication
(10) Pub. No.: US 2010/0219595 A1
(43) Pub. Date: Sep. 2, 2010

(54) Drill adapter for an air impact wrench

(76) Inventor: Maxwell Moore, Martin County, KY (US)

Correspondence Address: Gary K.. Price, Esq;Terrell, Baugh, Salmon & Born, LLP, Suite 2000, 700 South Green River Road, Evansville, IN, 47715, US

(21) Appl. No.: 12/660,431

(22) Filed: Feb. 26, 2010

Related U.S. Application Data
(60) Provisional application No. 61/208,809, filed on Feb. 27, 2009.

(51) Int. Cl. B25F 3/00

(52) U.S. Cl. 279/144

(57) ABSTRACT

A drill adapter for attaching to an air impact wrench. With attachment of the drill adapter, the air impact wrench can operate as a power drill for drilling bores in a workpiece. The drill adapter generally includes a body having a shaft receiving end and a drill chuck. The shaft receiving end includes a holding section sized and shaped for receiving the tool spindle or shaft of an air impact wrench. The drill chuck includes a plurality of jaws for clamping to a drill tool and tightening means for tightening or releasing the drill tool from the jaws. In operation, the tool spindle of a powered turning impact wrench is engaged within the holding section of the drill adapter. A drill tool is received in the drill chuck. When the impact wrench is fully engaged with the attachment described, the rotation torque output of the air impact wrench turns the drill adapter resulting in the air impact wrench operating as a power drill to form bores in a workpiece.

### CROSS REFERENCES TO RELATED APPLICATIONS

U.S. Provisional Application for Patent No. 61/208,809, filed Feb. 27, 2009, with title “Drill Adapter for an Air Impact Wrench” which is hereby incorporated by reference. Applicant claim priority pursuant to 35 U.S.C. Par. 119(e)(i).

### STATEMENT AS TO RIGHTS TO INVENTIONS MADE UNDER FEDERALLY SPONSORED RESEARCH AND DEVELOPMENT

Not Applicable.

### BACKGROUND OF THE INVENTION

1. Field of the Invention

This invention relates generally to a drill adapter for attaching to an air impact wrench and having a means for releasably securing the drill adapter on the attachment region of the impact wrench such that the drill adapter can be selectively mounted on or disconnected from the attachment region and more particularly, a drill adapter for receiving a selected drilling tool and rotatable relative to the torque transmitting means of the tool spindle of the air impact wrench.

2. Brief Description of Prior Art

The drawback of the known prior art is that an air impact wrench has its particular functions and advantages and likewise, the power drill has its functions. However implementation of these combined functions require two (2) tools—the air impact wrench and power drill. In some applications such as mining where space is limited for example, access to multiple pieces of equipment is always burdensome, and often difficult if not impossible.

The Inventor is unaware of a drill adapter as will be described that will expand the function of an air impact wrench so that the impact wrench can also be used for performing power drill functions such as, but not limited to, drilling holes. As a result, it is possible to form bores in a workpiece with an air impact wrench having a drill adapter of the type described herein.

As will be seen from the subsequent description, the preferred embodiments of the present invention overcome disadvantages of the prior art. Again, to the Inventor's knowledge, there is no known drill adapter attachable to an air impact wrench as described below.

### SUMMARY OF THE INVENTION

A drill adapter for an air impact wrench having a shaft receiving end and a drilling tool receiving end. The shaft receiving end includes a holding section sized and shaped for receiving the tool spindle or shaft of an air impact wrench. The drilling tool receiving end includes a plurality of jaws for clamping to a selected drill tool and tightening means for clamping to and releasing the drill tool from the jaws. In operation, the tool spindle or shaft of a powered turning impact wrench is engaged within the shaft receiving end of the drill adapter. A selected drill tool is received in the drilling tool receiving end. When the impact wrench is fully engaged with the attachment described, the rotation torque output of the air impact wrench turns the drill adapter resulting in the air impact wrench operating as a power drill for performing power drill functions such as, but not limited to, forming bores in a workpiece.

### BRIEF DESCRIPTION OF THE DRAWINGS

FIGS. 1 and 2 are perspective views of a preferred embodiment of the present invention, a drill adapter for attaching to an air impact wrench.

FIG. 3 is an end view of the shaft receiving end of the drill adapter of FIG. 1.

FIG. 4 shows the drilling tool receiving end of the drill adapter.

### DESCRIPTION OF THE PREFERRED EMBODIMENT

The apparatus of the present invention is directed to a drill adapter for attachment to an air impact wrench. With the attachment of the drill adapter, the air impact wrench can operate as a power drill for performing power drill functions such as, but not limited to, drilling bores in a workpiece. More specifically, the drill adapter of the present invention defines an attachment that can be selectively mounted on the impact wrench when functions of a power drill are required, or disconnected from the air impact wrench when standard functions of the air impact wrench are required. Regardless, the drill adapter as disclosed allows a standard air impact wrench to function as two (2) distinct power tools—an air impact wrench or a power drill.

In the broadest context, the drill adapter as disclosed consists of components configured and correlated with respect to each other so as to attain the desired objective.

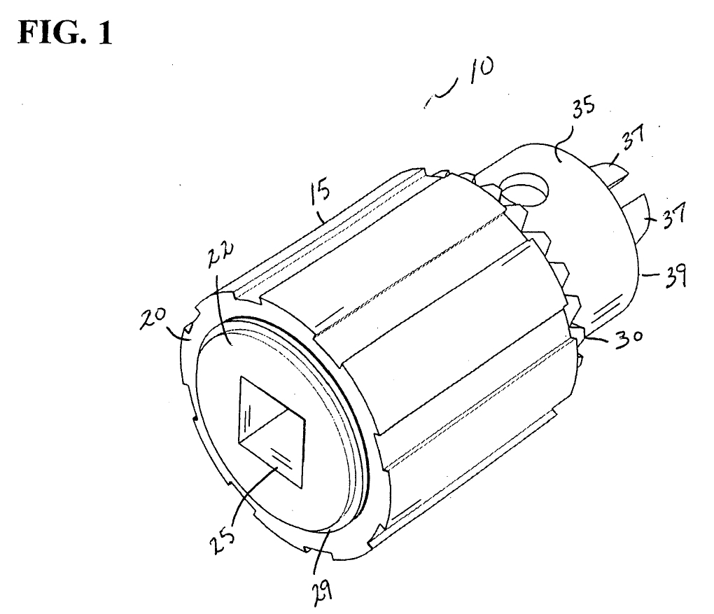

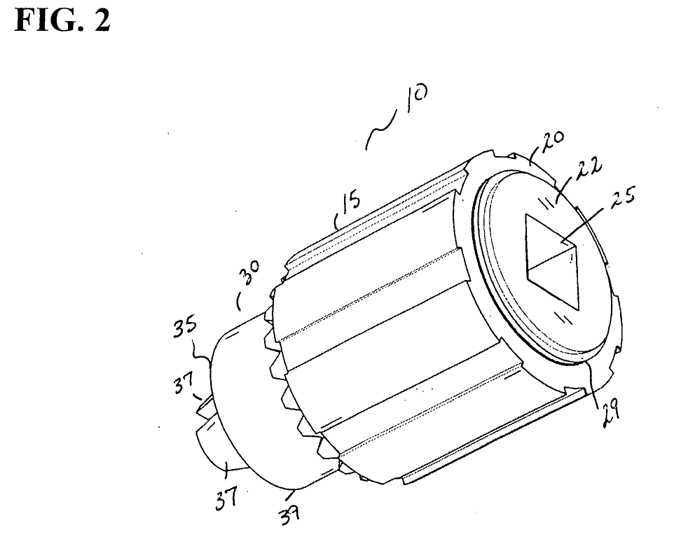

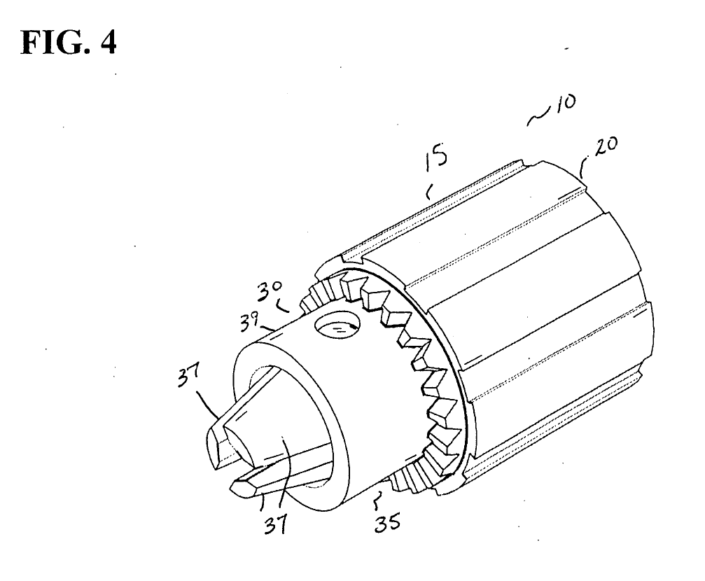

FIGS. 1-4 show a drill adapter for an air impact wrench in accordance with the present invention. The device designated as numeral 10 generally includes a body 15 having a first end 20 adapted for receiving a tool spindle or shaft of a prior art air impact wrench (not shown) and a second end 30 opposite the first end 20, which second end 30 defines a drill chuck 35 for receiving selected drilling tools.

A prior art air impact wrench includes a tool spindle or shaft that rotates relative to the torque transmitting means of the impact wrench. The first end 20 of the drill adapter 10 includes a surface 22 having a holding section 25 sized and shaped for sliding receipt of the impact wrench's tool spindle or shaft. The holding section 25 further includes means 29 known in the art for releasably securing the tool spindle or shaft of the air impact wrench within the holding section 25.

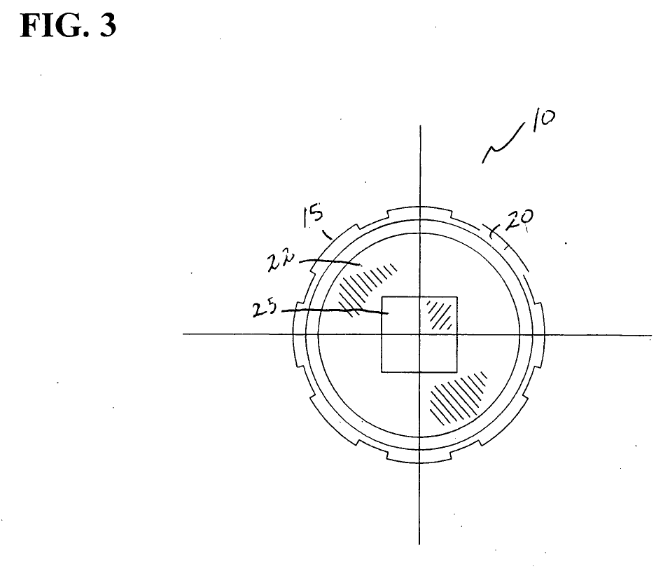

The holding section 25 is provided with a cross-sectional configuration (best shown in FIG. 3) for matingly receiving the tool spindle or shaft therein.

The drill adapter 10 turns as the tool spindle of the impact wrench is turning. A selected drilling tool received in the second end 30 of the adapter 10 as will be further described will likewise turn as the connected first end 20 turns.

The second end 30 of the drill adapter 10 defines a drill chuck 35 for receiving and releasably clamping a selected drilling tool (not shown) within a plurality of jaws 37. The drill chuck 35 further including tightening means 39 known in the art for tightening and releasing the drilling tool within the plurality of jaws 37.

In operation, the tool spindle of a powered turning impact wrench (not shown) is engaged or “pushed” within the holding section 25 of the drill adapter 10 as previously disclosed. A selected drilling tool is received in the drill chuck 35 of the second end 30 as also previously described. When the impact wrench is fully engaged with the attachment described, the rotational torque output of the air impact wrench turns the drill adapter 10 resulting in the air impact wrench operating as a power drill for performing power drill functions such as, but not limited to, forming bores in a workpiece.

While the best mode for carrying out the invention has been described, those familiar with the art to which this invention relates will recognize various alternative designs and embodiments for practicing the invention. Thus, the above-described preferred embodiment is intended to be illustrative of the invention which may be modified within the scope of the appended claims.

I claim:

1. A drill adapter for attaching to a standard air impact wrench so that the air impact wrench functions as two (2) distinct power tools, an air impact wrench or a power drill, said drill adapter comprising:
a body having a first end, and a second end opposite the first end,
wherein said first end adapted for receiving a tool spindle of an air impact wrench, and wherein said second end defines a drill chuck for receiving a selected drilling tool,
wherein said first end includes a surface having a holding section sized and shaped for sliding receipt of the impact wrench's tool spindle, and holding means for securing the tool spindle within said holding section such that said drill adapter turns as the tool spindle of the impact wrench is turning,
said drill chuck includes a plurality of clamping jaws, and tightening means for tightening and releasing the selected a drilling tool within said plurality of clamping jaws.

2. A drill adapter for an air impact wrench, said drill adapter comprising:
a body having a first end that is an air impact wrench shaft receiving end, and a second end that is a drilling tool receiving end;
wherein said shaft receiving end includes a surface defining a holding section sized and shaped for receiving a tool spindle or shaft of the air impact wrench, and holding means for securing the shaft within said holding section such that said drill adapter turns as the shaft of the impact wrench is turning;
wherein said drilling tool receiving end includes a plurality of clamping jaws, and tightening means for tightening and releasing a selected drilling tool within said plurality of clamping jaws.

3. The drill adapter as recited in claim 2, wherein said first end is opposite said second end.

4. The drill adapter as recited in claim 3, wherein said holding section is sized and shaped for sliding receipt of the tool spindle or shaft of the air impact wrench.

5. A drill adapter comprising:
a first end having a surface that defines a holding section sized and shaped for receiving a tool spindle of an air impact wrench, and holding means for securing the tool spindle within said holding section such that said drill adapter turns as the tool spindle of the impact wrench is turning;
a second end, opposite said first end, said second end including a plurality of clamping jaws, and tightening means for tightening and releasing a selected drilling tool within said plurality of clamping jaws.

6. The drill adapter as recited in claim 5, wherein said holding section is sized and shaped for sliding receipt of the tool spindle of the air impact wrench.
